(19) United States
(12) Patent Application Publication
(10) Pub. No.: US 2003/0029210 A1
(43) Pub. Date: Feb. 13, 2003

(54) Exterior door handle system

(76) Inventors: Edgar Budzynski, Dortmund (DE); Matthias Koerwer, Wuppertal (DE); Stephan Schmitz, Koln (DE)

Correspondence Address: NIXON PEABODY, LLP, 8180 GREENSBORO DRIVE, SUITE 800, MCLEAN, VA, 22102, US

(21) Appl. No.: 10/148,269

(22) PCT Filed: Nov. 29, 2000
(86) PCT No.: PCT/EP00/11909

(30) Foreign Application Priority Data
Nov. 29, 1999 (DE) 299 23 706.0

(51) Int. Cl. E05B 49/00

(52) U.S. Cl. 70/278.1; 70/264

(57) ABSTRACT

An outside door handle arrangement and a process for controlling a motor vehicle door lock system are proposed. For simple, economically feasible detection of the actuation of an outside door handle, it is provided that the outside door handle is elastically deformable and deformation is detected by a sensor to acquire actuation.

This invention relates to an outside door handle arrangement according to the preamble of claim 1 and a process for controlling a motor vehicle door lock system as claimed in the preamble of claim 32.

Electromechanical motor vehicle door lock systems are known. After unlocking, for example, by means of radio remote control, the operator pulls on the outside door handle of a motor vehicle door, the assigned motor vehicle door lock being opened by a control signal being output to the opening drive for lifting the detent pawl of the motor vehicle door lock by a sensor assigned to the outside door handle, especially a switch.

In the prior art there is preferably a movably supported outside door handle. Movable support is complex and susceptible.

The object of this invention is to devise an outside door handle arrangement and a process for controlling a motor vehicle door lock system so that actuation of the outside door handle can be reliably detected in an easy, economical manner, preferably without moving parts, especially in order to trigger an opening drive and/or a central interlock.

The aforementioned object is achieved by an outside door handle arrangement as claimed in claim 1 or a process as claimed in claim 32. Advantageous developments are the subject matter of the dependent claims.

The underlying idea of this invention is to make the outside door handle elastically deformable at least in areas and to detect deformation of the outside door handle by means of a sensor and to register it as actuation of the outside door handle. This idea as claimed in the invention leads to several advantages.

Simple, economical implementation is possible.

High operating reliability can be achieved. In particular, movable support of the outside door handle is not necessary. Accordingly, the outside door handle is made preferably stationary. In particular, the outside door handle has no movably supported parts. Outside door handles in this sense can be not only bow-type handles, but also flap handles.

A switch, button, or the like is not necessary in order to convert the opening motion into an electrical actuation signal for triggering an assigned motor vehicle door lock. Accordingly no moving parts which can cause failure or malfunctions are necessary.

The response behavior of the sensor is preferably such that a slight deformation of the outside door handle, particularly in an especially sensitive area, is enough for it to be possible to detect actuation of the sensor and/or the assigned electronics. Then for example motorized opening of an assigned motor vehicle door lock takes place. Depending on the required deformation path the deformability of the outside door handle is more or less imperceptible to the operator.

According to one preferred version, deformation of the outside door handle is sufficient, especially depressing one side wall of the outside door handle, with a maximum amplitude of preferably 0.01 mm to 1.0 mm, especially from 0.1 mm to 0.5 mm. Depending on the intended deformation path it can be necessary in signal evaluation to provide signal filtering and/or time windows—minimum and/or maximum time intervals in order not to interpret for example vibrations of the outside door handle in normal motor vehicle operation as actuation.

Preferably both tensile loading and also pressure loading of the outside door handle can be detected. Thus, very high functionality can be achieved. For example, locking of the motor vehicle door lock or a central interlock can take place when pressing on the outside door handle in a section which is especially sensitive to this.

According to one especially preferred embodiment the sensor is used both for detection of deformation of the outside door handle—therefore actuation sensing—and also detection of proximity, especially the hand of the operation, to the outside door handle, therefore proximity sensing. This can be achieved for example by the sensor working capacitively and having different response thresholds and/or different sensor elements or electrodes. In particular, it is provided that when proximity is detected the access authorization of the operator is checked, therefore a passive entry function is activated.

In contrast to pure pressure/tension detection, with a capacitive force sensor static forces can also be detected so that a constant force acting on the outside door handle produces a signal as long as it is present there. This can be used for example to keep the detent pawl raised as long as the outside door handle is being pulled. The sensor makes available the required signal which allows independent performance of this function.

Other aspects, properties, features and advantages of this invention arise from the following explanation of preferred embodiments which are shown in the drawings.

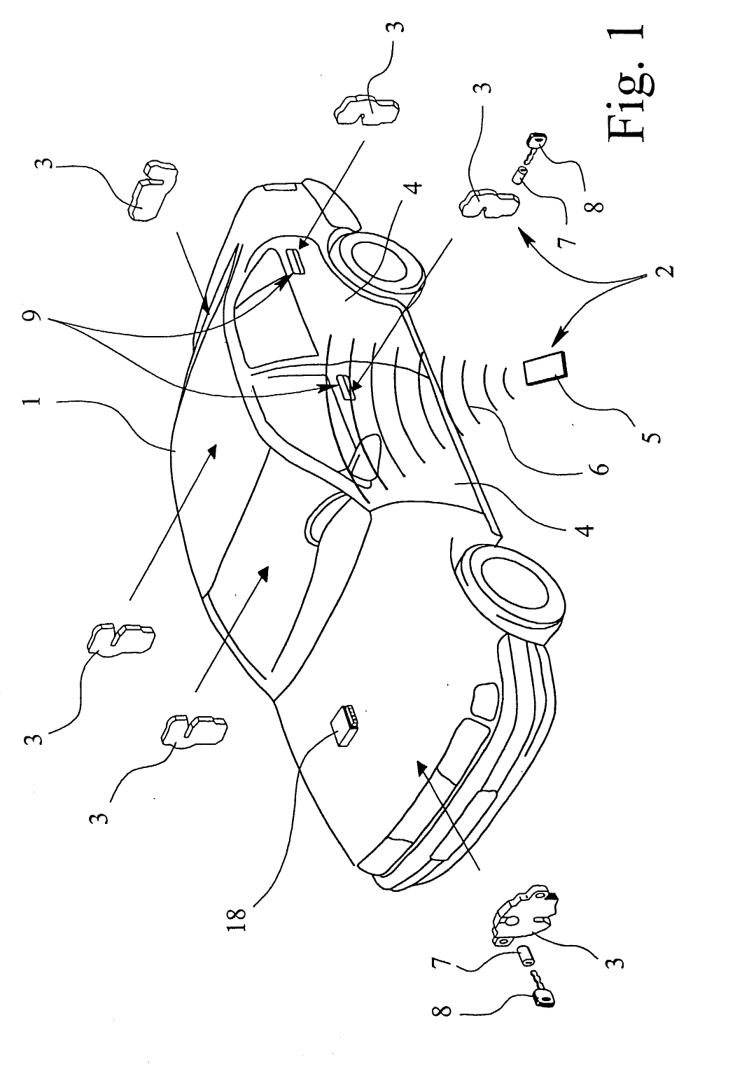

FIG. 1 shows a schematic perspective view of a motor vehicle with a motor vehicle door lock;

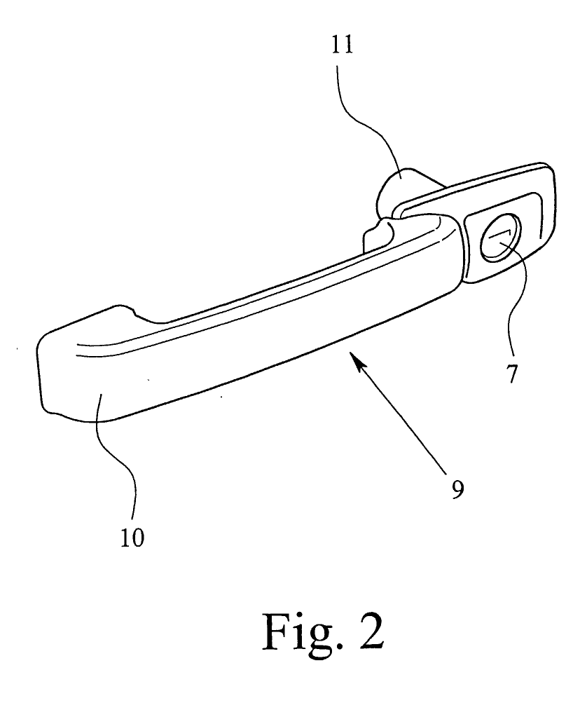

FIG. 2 shows an outside door handle arrangement of the motor vehicle door lock system as shown in FIG. 1;

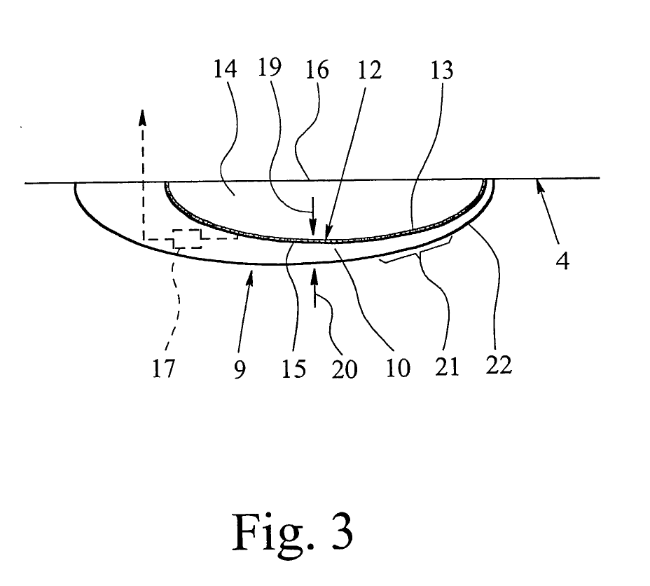

FIG. 3 shows a schematic overhead view of the outside door handle arrangement;

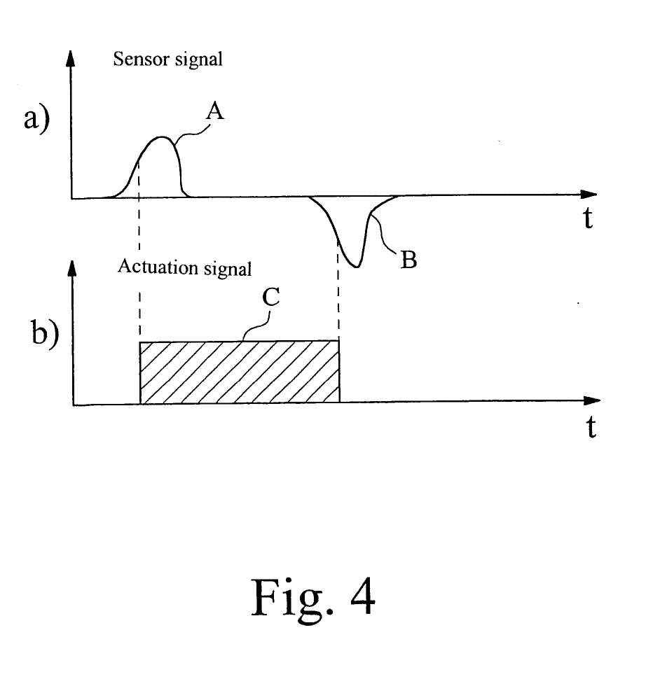

FIG. 4a, b show schematic signal diagrams when tensile loading is detected;

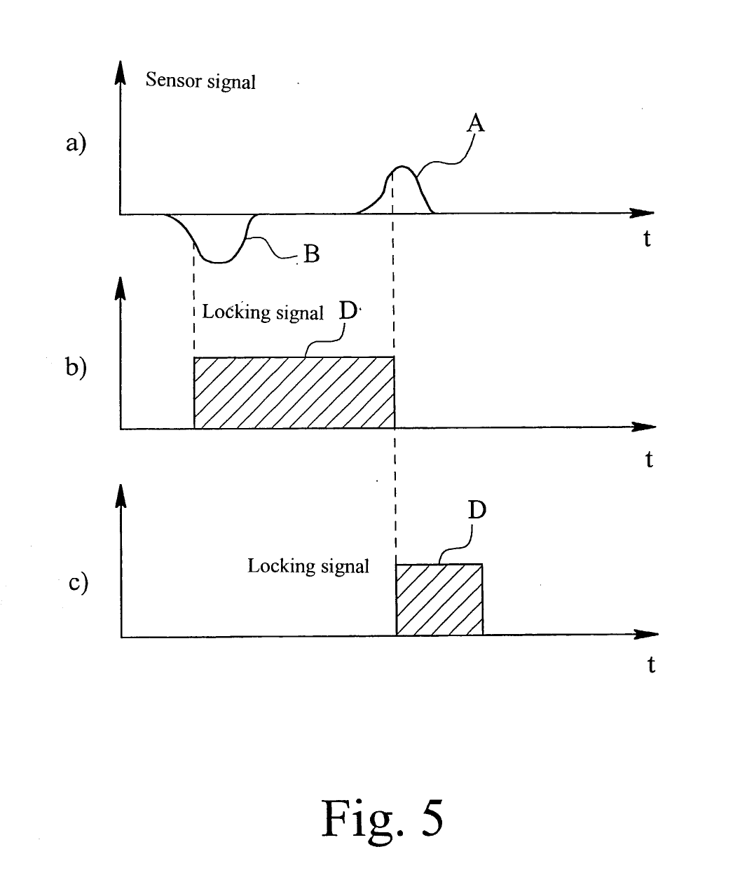

FIG. 5a, b show schematic signal diagrams when pressure loading is acquired; and

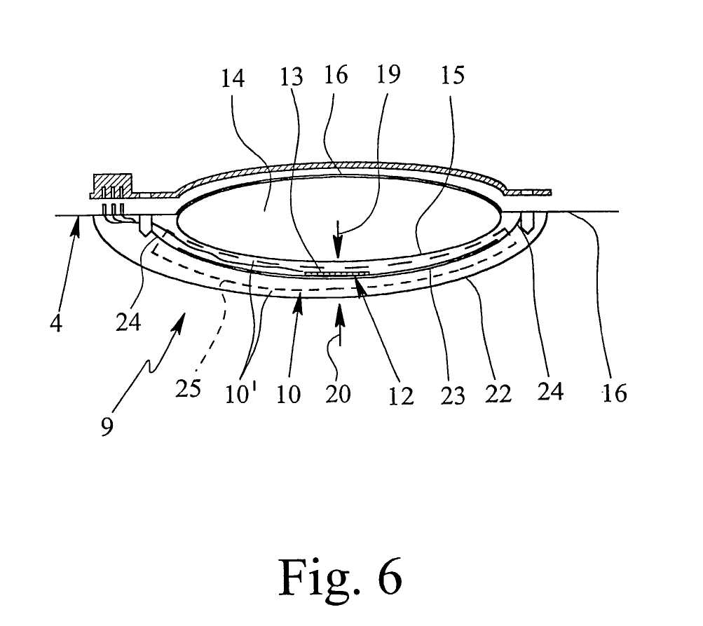

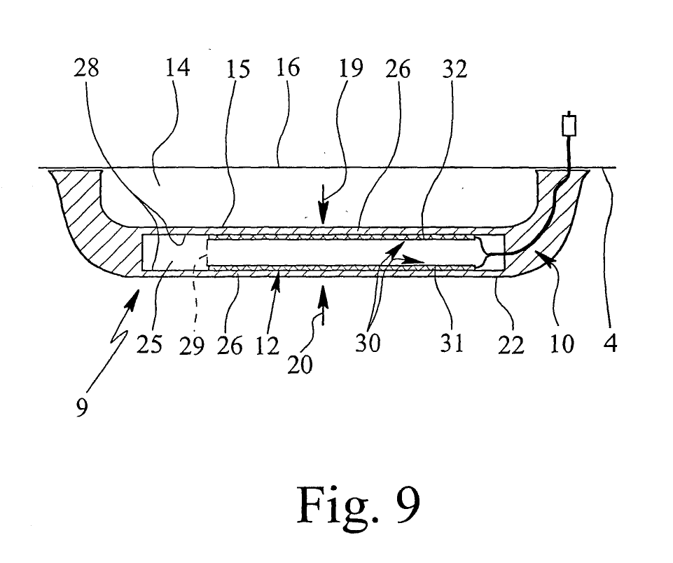

FIGS. 6, 9 show schematic cross sections of other outside door handle arrangements.

The same reference numbers are used for the same or similar parts, and the corresponding or comparable advantages and properties arise, even if a repeated description is omitted.

FIG. 1 schematically shows a motor vehicle 1 with a motor vehicle door lock system 2 as claimed in the invention. The motor vehicle door lock system 2 has especially several vehicle locks 3, especially for the vehicle doors 4, the rear hatch, the hood and the like, with installation positions which are shown schematically in FIG. 1.

Preferably each motor vehicle lock 3 can be locked and unlocked by a motor, especially an electric motor, by means of a known central interlock system or a central interlock drive. In the version as an electric lock, which is provided especially in the motor vehicle locks 3 of the vehicle side doors 4, each motor vehicle lock 3 additionally has the possibility of motorized opening, therefore lifting of the detent pawl which is not shown, by means of an opening drive which is not shown. Locking and unlocking can also be accomplished accordingly only using circuitry.

The motor vehicle door lock system 2 is preferably equipped with a “passive entry” function. Here a passive entry function is defined especially as automatic, vehicle-side data interrogation or identification of an operator-side data medium, a transponder 5 or the like, in order to ascertain whether an operator approaching the motor vehicle 1 or an operator already about to open the vehicle 1 or the vehicle door 4 is authorized for access. This is generally checked by the corresponding electronics of the motor vehicle 1. With the corresponding authorization of the operator, ordinarily automatic unlocking either of a central interlock system, of the door lock 3 of the driver-side door 4, or at least of the lock 3 of the door 4 being approached by the operator or the outside door handle the operator is touching or activating takes place.

In the embodiment the motor vehicle door lock system 2 comprises a data medium which is made as a “passive entry” chip card or other data medium or a transponder 5 which is carned by an operator who is not shown, and which is used as an “electronic key”. Thus, dala interrogation or identification of the data medium or transponder 5 which is triggered on the motor vehicle-side, as indicated by the signal waves 6, can be carried out and the access authorization of the operator can be checked. With the corresponding access authorization preferably all the motor vehicle locks 3 are unlocked by means of the central interlock system which is not shown, or the like.

If necessary one lock cylinder 7 at a time for actuation with a mechanical key 8 is assigned to the motor vehicle lock 3 of the driver's door and the hood lock. Thus the motor vehicle lock 3 of the driver's door can be mechanically actuated or unlocked in an emergency with the key 8 and opened. There can be the corresponding emergency unlocking or emergency opening if necessary also for the motor vehicle door locks 3 of the other doors 4.

One outside door handle arrangement 9 is assigned to at least each motor vehicle door lock 3 of the motor vehicle side doors 4, as shown in FIG. 1. FIG. 2 shows the outside door handle arrangement 9 of the driver's door with an integrated lock cylinder 7 which is supported for example in a guide element 11. But the lock cylinder 7 and its guide element 11 can also be omitted if necessary.

The outside door handle arrangement 9 furthermore has an outside door handle 10 which is made stationary and which has no moving parts, such as a movable actuating and opening lever or the like. A bow-shaped handle is shown, a flap handle could likewise be used.

The outside door handle arrangement 9 can moreover comprise an adjacent door area which is not shown in FIG. 2, especially when the outside door handle arrangement 9 together with this adjacent door area is inserted as a unit into the assigned motor vehicle door 4. But this is not absolutely necessary based on the stationary outside door handle 10. Rather, a so-called return plate of the outside door handle arrangement 9 can also be omitted and instead the engagement space can be defined or formed directly by the assigned motor vehicle door 4 on the one hand and the outside door handle 10 on the other.

FIG. 3 shows in a schematic overhead view an outside door handle arrangement 9 which is described for example as with regard to FIG. 2, but can also be made without the lock cylinder 7.

In the outside door handle arrangement 9, as is shown in FIG. 3, a sensor 12 is assigned to the outside door handle 10. Especially here a deformation-sensitive, force-sensitive and/or pressure-sensitive sensor element 13 is located on the outside door handle 10, as shown in FIG. 3, or is connected to it or integrated into it in some other way.

The sensor element 13 is especially a piezoelement in the aforementioned sense. Here it is a piezocrystal which upon deformation by charge displacement produces an electrical voltage, especially on its sides perpendicular to the direction of deformation. Preferably capacitive evaluation takes place, therefore detection of the charge displacement or capacitance changes when the piezoelement is deformed. But for example resistive evaluation is also possible.

The sensor 12 or the sensor element 13 has a minimum, or, especially when using a piezoelement, no power demand at all, so that there is a power demand which is small anyway for the evaluation which is especially continually carried out on a repeated basis for checking whether actuation of the outside door handle 10 has been detected.

The outside door handle 10 bounds or defines an engagement space 14 for the hand of the operator which is not shown. The “engagement space” here is accordingly defined especially as the space in which the hand of an operator which is not shown preferably fits to actuate the outside door handle 10.

The sensor element 13 in the embodiment as shown in FIG. 3 is located on the inside wall or the inner side 15 of the outside door handle 10 facing the engagement space 14. In particular, the sensor element 13 covers the inner side 15 and/or the adjoining areas of the outside door handle 10 over a large area, preferably essentially completely.

Preferably the sensor element 13 is however integrated into the outside door handle 10, especially located within.

The outside door handle 10 is, at least in areas, made elastically deformable. The sensor 12 can detect deformation of the outside door handle 10 which is caused by actuation, so that actuation can be detected.

The outside door handle 10 is made stationary, i.e. it is rigidly connected to the assigned motor vehicle door 4 or the assigned door area 16 or other parts of the outside door handle arrangement 9.

Preferably an evaluation unit or electronics 17 is assigned to the sensor 12, as indicated in FIG. 3, and is at least partially, especially completely integrated into the outside door handle arrangement 9 or the outside door handle 10.

Alternatively or in addition, the evaluation electronics 17 can be at least partially integrated into an assigned motor vehicle door 4 or central motor vehicle or control electronics 18 of the motor vehicle 1 which is shown in FIG. 1.

When the hand of an operator which is not shown grasps and deforms (actuates) the outside door handle 10, this leads to a corresponding change of the measurement signals and/or characteristics of the sensor 12 or the sensor element 13 which can be evaluated as contact and/or actuation of the outside door handle 10. In particular, a corresponding signal is output from the evaluation electronics 17, for example to the central motor vehicle electronics 18.

According to one preferred development, the sensor 12 and the optional evaluation electronics 17 are made such that it is possible to differentiate between initial touching and actual actuation of the outside door handle 10 by the hand of an operator which is not shown. In particular, the intensity of the measurement signal change at the sensor 12, therefore for example the intensity of the deformation of the outside door handle 10, is detected and evaluated. Here the increase of the deformation over time and/or the time interval between exceeding certain response thresholds can also be considered in order for example to detect the conventional rising of measurement values or changing of measurement values during the normal course of touching and subsequent activation of the outside door handle 10.

The preferred detection or evaluation of actuation of the outside door handle 10—therefore the sensing of actuation—is detailed below with reference to the schematic diagrams from FIG. 4.

FIG. 4a) shows by way of example the behavior of the signal which has been prepared or output by the sensor 12 or the sensor element 13. When an operator who is not shown actuates the outside door handle 10—therefore pulls it—this is registered by the sensor 12 or the sensor element 13 and output as a first signal A. In the preferred use of a piezoelement as a sensor element 13 or another sensor element which is sensitive or reacts only to changes, only a brief first signal A arises, as shown.

When the outside door handle 10 is released, a second signal B is output, as is likewise indicated in FIG. 4a). The second signal B is also present only for a short time.

The start and end of actuation of the outside door handle 10 are derived from the first signal A and the second signal B. Accordingly, depending on the detection of the first signal A and the detection of the second signal B an actuation signal C is determined, as shown for example or schematically in FIG. 4b). Depending on the actuation signal C, the motor vehicle door lock 3 assigned to the actuated outside door handle 10 is opened by motor, if the motor vehicle door lock 3 is already unlocked and/or the corresponding access authorization is present or is detected by the control electronics 18.

The unlocking of the motor vehicle door lock 3 can also be switched by actuating the outside door handle 10. For example, it can be provided that by simply briefly pulling on the outside door handle the motor vehicle door lock 3 is unlocked and by pulling for a longer time or pulling twice motorized opening of the motor vehicle door lock 3 takes place. It can be assumed in any case that there is corresponding access authorization.

The evaluation and preparation of an actuation signal C as claimed in the invention can take place especially by the evaluation electronics 17. But evaluation can alternatively also take place in the control electronics 18 or in some other means of the motor vehicle 1.

Depending on the configuration, it is not necessary for the actuation signal C to be produced or output. Rather the actuation signal C can also be defined as the logic state of the control, especially of the control electronics 18 or the like. Depending on this logic state, the assigned motor vehicle door lock 3, as already explained, can be locked and unlocked, opened and closed.

The motor vehicle door lock 3 is opened especially by the detent pawl of the motor vehicle door lock 3 which is not shown being raised during the opening state or being moved into a non-blocking state.

In the embodiment the first signal A and the second signal B have opposite polarities and opposite time responses. This facilitates detection. Advantageously this behavior occurs in the preferably used piezoelement and capacitive evaluation.

Detection can take place for example by detecting a certain (positive or negative) threshold value of a (positive or negative) rate of change—therefore time derivation—and/or an integral value or the like being exceeded in the signal made available by the sensor 12 or the sensor element 13 and by its being evaluated as the first signal A or the second signal B. Of course, here other suitable detection criteria or algorithms can also be used.

The actuation sensing as claimed in the invention is not limited to the first signal A and the second signal B having opposite polarities or time response. This is advantageous, but not necessary in the corresponding detection criteria.

Furthermore, the actuation sensing as claimed in the invention can also take place when the sensor 12 or the sensor element 13 makes available a signal which for example is present for the entire duration of actuation of the outside door handle 10, optionally with certain fluctuations. This is the case for example in a sensor 12 or sensor element 13 in which the sensor signal is proportional to the acting force or the acting pressure. The first signal A can be detected for example as the edge—great rise over time—of the sensor signal and the second signal B as the opposite edge—great drop over time—of the sensor signal.

In addition, it should be pointed out that actuation sensing can also be used to control other motor vehicle functions and to activate other motor vehicle controls. Preferably the corresponding control signals such as the actuation signal C are output by the evaluation electronics 17 or other electronics, such as the control electronics 18.

So far, primarily only the detection of touching or actuation of the outside door handle 10 has been addressed. In this conventional touching or actuation of the outside door handle 10, usually a tensile load, as is indicated by the arrow 19 in FIG. 3 and FIGS. 6 to 10, is applied to the outside door handle 10. Touching of the outside door handle 10 therefore takes place at least essentially on the inner side 15 of the outside door handle 10 facing the engagement space 14. The actuation or tensile load 19 is accordingly pointed away from the assigned motor vehicle door 4 or the assigned door area 16.

One aspect is that a pressure load on the outside door handle 10—indicated essentially by the arrow 20—can be detected, especially in addition. Especially pressing, for example of the hand of an operator which is not shown, on the outside door handle 10 in the preferably marked area 21 on the outside 22 or other suitable area of the outside door handle 10 can be detected. The pressure load 20 can be detected in addition or alternatively to detection of the tensile load 19.

In particular, the detection of a pressure load 20 can take place by a corresponding evaluation of the signals A and B which have already been used to detect the tensile load 19, as shown in FIG. 5. When the second signal B occurs first and afterwards the first signal A, especially within a predetermined time window or interval, as indicated in FIG. 5a), this can be evaluated as a locking signal D, as shown in FIG. 5b). The locking signal D however can also be produced or output only after detection of the first signal A within a time window which is not shown, as in the case as shown in FIG. 5c). FIG. 4 illustrates complete signal generation in conjunction with FIG. 5. Signal evaluation in the control electronics leads to the control versions which are then desired.

But, as already explained, detection of a pressure load 20 of the outside door handle 10 or its preferably especially sensitive section 21, which load is sufficient for executing a function and which optionally exceeds a predetermined response threshold, can also conventionally take place in some way other than by detection and evaluation of the signals A, B, for example by means of the sensor 12 or an additional sensor.

When a pressure load 20 is detected or when the closing signal D is present, it is provided that the assigned motor vehicle door lock 3 or especially all the motor vehicle door locks 3 are locked, therefore especially a central interlock which is not shown or the like is activated. When the motor vehicle door locks 3 are made as locks which can be opened by motor or electric locks, locking can also take place if necessary solely using circuity.

Preferably the outside door handle arrangement 9 or the outside door handle 10 is made such that the sensor 12 can sense both a tensile load 19 and also a pressure load 20, overall therefore only one sensor 12 is necessary. If necessary, however there can also be several sensors 12 and/or sensor elements 13 with regard to redundancy aspects and/or for selective detection of a tensile load 19 or a pressure load 20.

In the embodiment shown in FIG. 3, if there is detection of a pressure load 20 at all, the outside door handle 10 is made elastically deformable enough so that under a pressure load 20 the corresponding deformation of the sensor 12 or of its sensor element 13 can be detected.

In the embodiment as shown in FIG. 6, the outside door handle 10—as in all the embodiments described here—is made preferably at least essentially stationary. The outside door handle 10 therefore, even in a multipart execution, has no moving parts in the sense of a switch, button, or the like. This moreover enables a simplified structure of the outside door handle arrangement 9, since movable support of parts or the like is eliminated.

The outside door handle 10 or at least parts or sections of it is or are elastically deformable such that especially in the case of the embodiments as shown in FIGS. 6 to 10 both a tensile load 19 and also a pressure load 20 can be detected.

In the embodiment as shown in FIG. 6, the outside door handle 10 is made in several parts, here it is formed from two outside door handle parts 10′.

Within the outside door handle 10, there is a preferably strip-shaped support 23 to which the sensor 12 or its sensor element 13 is assigned. In particular, as the sensor element 13 a piezoelement is connected to the support 23 and optionally located on it. For example, the support 23 can have a corresponding recess so that it is possible to act on the sensor element 13 from both sides, or there can be a sensor element 13 on both sides of the carrier 23.

The support 23 is preferably securely connected to the outside door handle 10 only in opposing end areas 24 and extends otherwise at least essentially within the cavity 25 formed in the outside door handle 10. The support 23 is made strip-shaped and extends preferably roughly over the entire length of the outside door handle 10 or at least an essential part of it. The support 23 is made preferably rigid, at least in relation to the other outside door handle 10 or its parts 10′. It consists essentially of metal, but can also be produced from plastic.

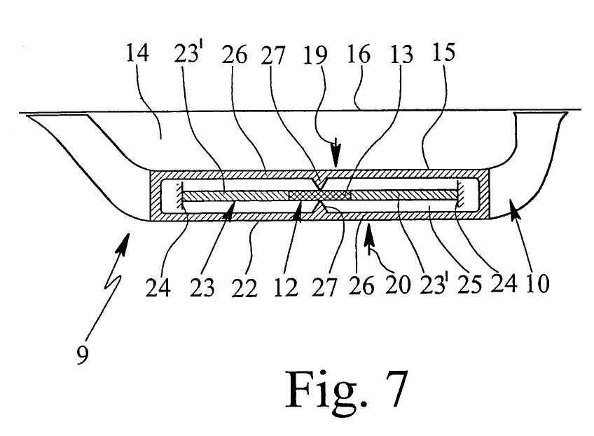

Very good response behavior is achieved especially by the fact that according to the schematic as shown in FIG. 7 elastically deformable or impressible side walls 26 of the cavity 25 or of the outside door handle 10 can act directly or via the projections 27 on the sensor 12 or its sensor element 13 with a corresponding load on the outside door handle 10. In particular, application of force over a very small area, essentially at a point in the limiting case, leads to especially good response behavior even when using a piezoelement as the sensor element 13. But for example a strain gauge or the like can also be used as the sensor element 13 if necessary.

Preferably the projections 27 are made hemispherical, pin-like, in the shape of a truncated cone, or conically. Thus, application of force over a very small area and thus a high pressure are achieved; this promotes good response behavior.

The above described structure leads to the fact that at least partial deformation of the outside door handle 10 with high response sensitivity can be detected, its being possible to distinguish between a tensile load 19 and a pressure load 20.

As shown in FIG. 7, the sensor 12 or the sensor element 13 can also be located and held between two sections or parts 23′ of the support 23. But a sandwich structure with a continuous support 23, as in the representation in FIG. 6, is also possible.

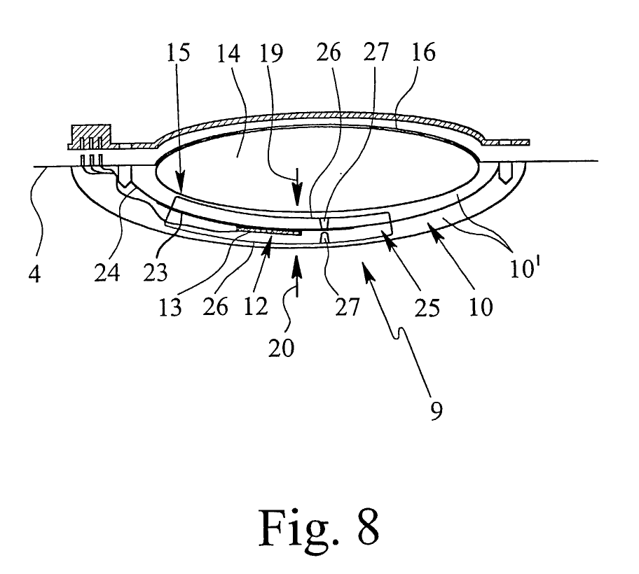

FIG. 8 shows another embodiment of the outside door handle arrangement 9 or of the outside door handle 10 which is very similar to FIGS. 6 and 7. Here there is an asymmetrical arrangement of the sensor 12 or its sensor element 13. There is no direct action of the side walls 26 and projections 27 on the sensor element 13, rather this action takes place indirectly via the support 23. Especially the carrier 23 is securely clamped only on one end area 24 and ends with the other end area between the side walls 26 and their projections 27. Accordingly, here deformation acts indirectly via the carrier 23 on the sensor 12 or the sensor element. Especially here the sensor element 13 when the outside door handle 10 is deformed is exposed optionally to bending and/or elongation or compression stress. This can of course also be the case in the embodiment as shown in FIGS. 6 and 7. Accordingly then for example a strain gauge or the like can be used as the sensor element 13.

FIG. 9 shows another embodiment. Here the sensor 12 has a least one electrode arrangement 30 as the sensor element 13. The electrode arrangement 30 in the embodiment shown comprises two electrodes 31 and 32 which are located for example in the area of the opposing inside walls of the outside door handle 10. In particular, the electrodes 31, 32 can be formed by metal foils on the inner sides 28 of the side walls 26 which can be elastically deformed or which can be depressed. Preferably the electrodes 31 and 32 are arranged such that one electrode 31 is adjacent to the outer side 22 of the outside door handle 10 or of the section 21 and the other electrode 32 is adjacent to the inner side 15 of the outside door handle 10 or to the engagement space 14. In particular, the electrodes 31, 32 extend transversely to the direction of the tensile load 19 or the pressure load 20 which is to be detected.

When the outside door handle 10 or a side wall 26 of the outside door handle 10 is deformed under a tensile load 19 or pressure load 20, the distance of the electrodes 31, 32 changes. Accordingly especially a change of capacitance takes place. The electrode arrangement 30 therefore forms primarily a capacitive sensor in this embodiment. But the electrode arrangement 30 can also work differently or can also be evaluated differently. For example, depending on the deformation of the outside door handle 10, also other electrical characteristics, such as inductance, resistance, impedance or the like can also be changed and evaluated to detect a tensile or pressure load 19, 20. Depending on the manner of operation and the material used with the corresponding, suitable, for example dielectric or magnetic, properties, the cavity 25 can also be omitted and for example can be replaced by a compressible area which is not shown.

In contrast to use of a piezoelement the use of a purely capacitive sensor can lead to the fact that static forces can also be detected. A constant force acting on the outside door handle 10 then generates a signal as long as this force is present. This has the advantage which is indicated in the general part of the description that for example the detent pawl can be kept raised as long as the outside door handle 10 is pulled.

In the embodiment the electrode arrangement 30 is not suited for differentiating between a tensile load 19 and a pressure load 20. There can be for example another electrode which is not shown, for differentiation. Alternatively or in addition, with a suitable material selection and with a suitable structure specific changes of electrical/magnetic characteristics can be achieved such that it is possible to differentiate between a tensile load 19 and a pressure load 20 even with only two electrodes 31,32.

Another advantage of the electrode arrangement 30 or when using a capacitive sensor 12 to sense actuation of the outside door handle 10 is that at the same time proximity sensing can also be accomplished. For example, with the electrode arrangement 30, by changing the electrical capacitances it can be detected when the hand (not shown) of an operator reaches into the engagement space 14. Accordingly therefore only one sensor 12 is necessary both for actuation sensing and also proximity sensing.

In addition, it should be pointed out that the electrode arrangement 30 can also make available signals comparable or similar to signals A, B, as shown in FIG. 4, especially in a capacitive evaluation. Therefore, a corresponding evaluation is possible.

Alternatively or in addition to the electrodes 31, 32, there can also be strain gauges, piezoelements or the like, especially on the inside walls.

Optionally electrodes 31, 32 can be connected to the measurement loop, like by the connection 29 indicated in FIG. 9, in order to detect deformations for example by changes of the inductivity or inductance.

Of course, the aforementioned versions of the outside door handle arrangement 9 or of the outside door handle 10 if necessary can also be combined with one another. For example, different or several sensors 12 or different or several sensor elements 13 can be assigned to the outside door handle 10 and especially integrated into them.

1. Outside door handle arrangement (9) for a motor vehicle door lock system (2), the outside door handle arrangement (9) having an outside door handle (10), especially for opening an assigned motor vehicle door lock (3), and a sensor (12) assigned to the outside door handle (10) for detecting actuation of the outside door handle (10), especially by the hand of an operator, characterized in that
the outside door handle (10) has no moving parts (10′), that the outside door handle (10) is made stationary and elastically deformable at least in areas, and that deformation of the outside door handle (10) can be detected by means of a sensor (12) as actuation of the outside door handle (10).

2. Outside door handle arrangement as claimed in claim 1, wherein the outside door handle (10) is elastically deformable on the inner side (15) which faces especially the assigned motor vehicle door (4).

3. Outside door handle arrangement as claimed in claim 1 or 2, wherein the outside door handle (10) is elastically deformable both under a tensile load (19) and also a pressure load (20), and especially the sensor (12) can detect both tensile loading (10) and also pressure loading (20) of the outside door handle (10).

4. Outside door handle arrangement as claimed one of the preceding claims, wherein the outside door handle (10) is elastically deformable at least in one marked section (21).

5. Outside door handle arrangement as claimed one of the preceding claims, wherein the outside door handle (10) is made in several parts.

6. Outside door handle arrangement as claimed one of the preceding claims, wherein the outside door handle (10) is made at least essentially rigid.

7. Outside door handle arrangement as claimed one of the preceding claims, wherein the outside door handle (10) is made hollow.

8. Outside door handle arrangement as claimed one of the preceding claims, wherein the sensor (12) has a sensor element (13) which is located on the outside door handle (10), is connected to it, or is integrated or installed in it.

9. Outside door handle arrangement as claimed one of the preceding claims, wherein the sensor (12) and/or the sensor element (13) of the sensor (13) is or are located and/or made at least essentially immovable.

10. Outside door handle arrangement as claimed one of the preceding claims, wherein the sensor (12) has at least one deformation-sensitive, force-sensitive and/or pressure-sensitive sensor element (13).

11. Outside door handle arrangement as claimed in claim 10, wherein the sensor element (13) is made as piezoelement.

12. Outside door handle arrangement as claimed in claim 10 or 11, wherein the outside door handle (10) and the sensor element (13) are made and/or arranged such that when the outside door handle (10) is deformed the sensor element (13) is exposed to a load only over a small area, especially a point.

13. Outside door handle arrangement as claimed one of claims 8 to 12, wherein the outside door handle (10) has an elastically deformable, especially compressible side wall (26), deformation of the outside door handle (10) or of the side wall (26) acting on the sensor element (13) or a carrier (23) which holds the sensor element (13), especially exerts a force.

14. Outside door handle arrangement as claimed in claim 13, wherein the side wall (26) has a projection (27) which points toward the sensor element (13) and which upon the corresponding deformation of the outside door handle (10) or of the side wall (26) acts on the sensor element (13) or the carrier (23), especially exerts a force.

15. Outside door handle arrangement as claimed in claim 14, the wherein the projection (27) is made pin-like, conical, in the shape of a truncated cone, or hemispherical.

16. Outside door handle arrangement as claimed one of claims 12 to 15, wherein the sensor element (13) or the carrier (23) which holds the sensor element (13) is located between two elastically deformable, especially compressible side walls (26) of the outside door handle (10) so that deformations of the side walls (26) act differently on the sensor element (13) or the carrier (23), especially exert opposed forces.

17. Outside door handle arrangement as claimed one of claims 13 to 16, wherein the side wall(s) (26) borders or border a cavity (25) of the outside door handle (10).

18. Outside door handle arrangement as claimed one of claims 8 to 17, wherein the sensor element (13) is located on an especially strip-shaped carrier (23).

19. Outside door handle arrangement as claimed in claim 18, wherein the carrier (23) is made rigid and/or supported preferably exclusively in opposing end areas (24) on the outside door handle (10).

20. Outside door handle arrangement as claimed in claim 18 or 19, wherein the carrier (23) with one end area (24) is held and/or ends between two opposing, elastically deformable side walls (26), especially projections (27) which are located on them.

21. Outside door handle arrangement as claimed one of the preceding claims, wherein the sensor (12) or its sensor element (13) and/or an assigned carrier (23) is or are located at least in part in a cavity (25) of the outside door handle (10).

22. Outside door handle arrangement as claimed one of the preceding claims, wherein the sensor (12) is made such that deformation of the outside door handle (10) can be acquired by detection of a change in an electrical characteristic, especially capacitance, inductance, impedance and/or resistance.

23. Outside door handle arrangement as claimed one of the preceding claims, wherein as the sensor element (13) the sensor (12) has an electrode arrangement (30), and especially deformation of the outside door handle (10) can be acquired by detection of a change of the capacitance, the inductance and/or the impedance of the electrode arrangement (30).

24. Outside door handle arrangement as claimed in claim 23, wherein the electrode arrangement (30) has two electrodes (31, 32) which are spaced apart.

25. Outside door handle arrangement as claimed in claim 24, wherein the distance of the electrodes (31, 32) can be changed depending on the deformation of the outside door handle (10).

26. Outside door handle arrangement as claimed in claim 24 or 25, wherein there is at least one electrode (31, 32) on or in an elastically deformable side wall (26) of the outside door handle (10).

27. Outside door handle arrangement as claimed in claim 26, wherein the electrodes (31, 32) are located on or in opposing elastically deformable side walls (26) of the outside door handle (10), especially on the inner sides of the side walls (26) facing one another.

28. Outside door handle arrangement as claimed in claim 26 or 27, wherein the side wall(s) (26) border(s) a cavity (25) and/or a compressible area of the outside door handle (10).

29. Outside door handle arrangement as claimed one of claims 24 to 28, wherein at least one electrode (31, 32) is made foil-like, is produced especially from metal foil.

30. Outside door handle arrangement as claimed one of claims 23 to 29, wherein the electrode arrangement (30) and/or at least one, preferably two, electrodes (31, 32) extends or extend at least partially transversely, especially vertically, to the main direction (19, 20) of deformation of the outside door handle (10).

31. Outside door handle arrangement as claimed one of claims 23 to 30, wherein proximity, especially of the hand of the operator to the outside door handle (10), is detected by means of the electrode arrangement (30), especially capacitively.

32. Process for control of a motor vehicle door lock system (2) with a motor vehicle door lock (3) and an outside door handle (10) which is assigned to the motor vehicle door lock (3) and which is made stationary and which has no moving parts (10′), actuation of the outside door handle (10), especially by the hand of the operator, being detected by means of a sensor (12) assigned to the outside door handle (10), the outside door handle (10) being monitored by means of the sensor (12) for deformation, the deformation, especially when a response threshold is exceeded, being detected as actuation of the outside door handle (10) and thereupon the motor vehicle door lock (3) is unlocked and/or opened.

33. Process as claimed in claim 32, wherein the sensor (12) converts deformation of the outside door handle (10) into electrical signals or changes of at least one electrical characteristic.

34. Process as claimed in claim 32 or 33, wherein tensile loading (19) of the outside door handle (10) and/or pressure loading (20) from deformation of the outside door handle (10) is detected, especially its being possible to distinguish between a tensile load (19) and a pressure load (20).

35. Process as claimed in one of claims 32 to 34, wherein the sensor (12) detects proximity, especially of the hand of an operator, to the outside door handle (10), especially capacitively, especially when proximity is detected access authorization being interrogated if the motor vehicle door lock (3) is locked, and/or the motor vehicle door lock (3) is unlocked if there is access authorization or it is established upon interrogation.
